(19) United States
(12) Patent Application Publication
(10) Pub. No.: US 2013/0078394 A1
(43) Pub. Date: Mar. 28, 2013

(54) Fire Retardants, Fire Retardant Synthetic Turf Products and Methods of Making Same

(71) Applicant: Leslie Jay Taylor, Acworth, GA (US)

(72) Inventor: Leslie Jay Taylor, Acworth, GA (US)

(73) Assignee: TEXTILE RUBBER AND CHEMICAL COMPANY, INC., Dalton, GA (US)

(21) Appl. No.: 13/246,286

(22) Filed: Sep. 27, 2011

(51) Int. Cl. A41G 1/00; C08K 3/26; C08K 3/30; B05D 7/24; C08L 33/10; C08L 23/06; B32B 5/16; B05D 5/00; C08K 3/22; C08K 3/32

(52) U.S. Cl. 428/17; 524/436; 524/437; 524/424; 524/5; 524/417; 428/402; 427/180

(57) ABSTRACT

The invention comprises a fire retardant composition comprising a fire retardant compound that thermally decomposes to release carbon dioxide or water or both and a thermoplastic polymer. The invention also comprises a fire resistant synthetic turf comprising a backing layer, a face fiber and infill material between the face fibers, the infill material comprises a flame retardant composition comprising a flame retardant compound that thermally decomposes to release carbon dioxide or water or both and a thermoplastic polymer. The invention also comprises a method of forming a fire resistant synthetic turf product.

### FIELD OF THE INVENTION

The present invention generally relates to fire retardants. More particularly, this invention relates to fire retardant for use with synthetic turf products. This invention also relates to fire retardant synthetic turf products. The present invention also relates to a method of making a synthetic turf product fire retardant. The present invention further relates to a fire resistant infill material for use with synthetic turf.

### BACKGROUND OF THE INVENTION

Synthetic turf has become popular for sport surfaces. There are over 6000 synthetic turf sports surfaces in North America today. These sports surfaces are located at both indoor and outdoor facilities. Synthetic turf is popular because, inter alia, it requires less maintenance and conserves water.

Synthetic turf is typically comprised of a polyethylene face fiber tufted in a polypropylene primary backing material coated with a polyurethane (or latex) back coat to hold the fibers in place. There are also synthetic turf products that use polypropylene or polyamide face fibers.

The face fibers in synthetic turf products forms resilient artificial “grass” blades. The grass blades are typically infilled with a granular filler material, which gives the turf a more natural appearance. Each “grass” blade usually stands above the infill material, with the infill material forming a layer adjacent the base of the blade; i.e., where the face fiber emerges from the backing material. Infill material is vital to the safety, durability and longevity of the synthetic turf product.

The term “infilled” means that the man-made grass blades are interspersed with an artificial topsoil that provides the necessary stability, uniformity and resilience to the turf. The infill material frequently comprises multiple layers, the bottom layers of which may comprise silica sand or a mixture of silica sand and ground rubber, especially ground recycled tire rubber. For mixing with the sand, the granulated recycled tire rubber is frequently cryogenically ground to a particle size approximately the same as the sand. Larger sized particles of cryogenically ground recycled tire rubber usually form the top layer. The rubber top layer makes the turf a more forgiving playing surface. The sand typically comprises approximately 70% by weight of the infill material and the ground rubber comprises approximately 30% by weight of the infill material. Other materials used as infill material include, but are not limited to, cork, polymer beads, synthetic polymer foam, styrene perlite, neoprene, EPDM rubber, hard aggregate, gravel, slag and granulated plastic.

Examples of synthetic turf products including infill material are shown in U.S. Pat. Nos. 6,818,274; 6,551,689 and 7,357,966 and U.S. Pat. App. Pub. Nos. 2005/0281963, 2006/0045995 and 2007/0009680 (the disclosures of which are all incorporated herein by reference).

Since synthetic turf products are made from materials that are flammable, it would be desirable to produce a synthetic turf product that is fire resistant. This is particularly true since some synthetic turf products are used indoors. It would also be desirable to provide a fire retardant that can be used in the manufacture of new synthetic turf products or for treating existing synthetic turf products.

### SUMMARY OF THE INVENTION

The present invention satisfies the foregoing needs by providing an improved fire retardant. The present invention also provides an improved synthetic turf product and a method for making a synthetic turf product fire retardant.

In one disclosed embodiment, the present invention comprises a composition. The composition comprises a fire retardant compound and a thermoplastic polymer. The composition is in the form of particles suitable for use as infill for synthetic turf products. In a further disclosed embodiment, the present invention comprises a composition comprising approximately 60% by weight magnesium hydroxide or aluminum trihydrate, approximately 25% by weight ethylene methyl acrylate and approximately 15% by weight low density polyethylene.

In another disclosed embodiment, the present invention comprises a synthetic turf product. The synthetic turf product comprises a backing layer, a plurality of face fibers extending upwardly from the backing layer and infill material between the plurality of face fibers. The infill material comprises a fire retardant compound and a thermoplastic polymer in particulate form.

In a further disclosed embodiment, the present invention comprises a method. The method comprises applying to an upper surface of face fibers of a synthetic turf an amount of a fire retardant sufficient to make the synthetic turf fire resistant, the fire retardant composition is in particulate form and comprises a fire retardant compound and a thermoplastic polymer. The method also comprises dispersing the particulate fire retardant composition between adjacent face fibers and below the upper surface of the face fibers.

Accordingly, it is an object of the present invention to provide an improved fire retardant.

Another object of the present invention is to provide an improved synthetic turf product.

A further object of the present invention is to provide a fire resistant synthetic turf product.

Another object of the present invention is to provide a synthetic turf product that can achieve a Class 1 critical radiant flux rating.

Another object of the present invention is to provide a synthetic turf product that can achieve a Class 2 critical radiant flux rating.

Yet another object of the present invention is to provide a method for making synthetic turf products fire resistant.

Another object of the present invention is to provide a method for making fire resistant synthetic turf products.

Another object of the present invention is to provide a fire resistant synthetic turf product that is recyclable.

A further object of the present invention is to provide a fire retardant that is recyclable.

Another object of the present invention is to provide an improved infill material for synthetic turf.

Another object of the present invention is to provide a fire resistant infill material for synthetic turf.

These and other objects, features and advantages of the present invention will become apparent after a review of the following detailed description of the disclosed embodiments and the appended claims.

### DETAILED DESCRIPTION OF THE DISCLOSED EMBODIMENTS

The present invention comprises a fire retardant for use with synthetic turf products. The fire retardant composition comprises a fire retardant compound and a thermoplastic polymer. The fire retardant in accordance with the present invention is in particulate form, which is then added as infill for synthetic turf products. The fire retardant compound and the thermoplastic polymer are preferably combined in an extruder and then pelletized to form particles of a suitable size for use as infill for synthetic turf products.

The fire retardant compound in accordance with the present invention releases either carbon dioxide or water upon thermal decomposition. The fire retardant compounds that are known to release carbon dioxide or water or both upon thermal decomposition and are useful in the present invention preferably include, but are not limited to, magnesium hydroxide, aluminum trihydrate, Nesquehonite, gypsum, magnesium phosphate octahydrate, Hydromagnesite, Dawsonite, magnesium carbonate subhydrate, Bohemite, calcium hydroxide, Huntite and mixtures thereof. Preferred fire retardant compounds are magnesium hydroxide and aluminum trihydrate. Magnesium hydroxide has the chemical formula Mg(OH)₂ and is commercially available as a solid powder under the designation UltraMag 60-90 from Cimbar Performance Minerals, Cartersville, Ga. Magnesium hydroxide is desirable for use in the present invention because it has low corrosiveness and is non-toxic. Aluminum trihydrate (also know as aluminum trihydroxide or alumina trihydrate) has the chemical formula Al(OH)₃ and is commercially available as a solid powder under the designation SB 336 from Huber Engineered Materials, Atlanta, Ga. Nesquehonite has the chemical formula MgCO₃.3H₂O. Gypsum has the chemical formula CaSO₄.2H₂O. Magnesium phosphate octahydrate has the chemical formula Mg₃(PO₄)₂.8H₂O. Hydromagnesite has the chemical formula Mg₅(CO₃)₄(OH)₂.4H₂O. Dawsonite has the chemical formula NaAl(OH)₂CO₃. Magnesium carbonate subhydrate has the chemical formula MgO.CO₂[0.96]H₂O[0.3]. Bohemite has the chemical formula AlO(OH). Calcium hydroxide has the chemical formula Ca(OH)₂. Huntite has the chemical formula Mg₃Ca(CO₃)₄. Nesquehonite, Gypsum, magnesium phosphate octahydrate, Hydromagnesite, Dawsonite, magnesium carbonate subhydrate, Bohemite, calcium hydroxide and Huntite are commercially available naturally occurring minerals.

There are many thermoplastics that are suitable for use in the present invention. The only limitations on the thermoplastic are that it must be non-reactive with the fire retardant compound and the thermoplastic process temperature; i.e., the temperature at which the thermoplastic can be combined with the fire retardant compound, must be below the initial decomposition temperature of the fire retardant compound; i.e., the temperature at which the fire retardant compound decomposes to release carbon dioxide or water or both. The initial decomposition temperatures for the specific fire retardant compound listed above are shown in Table 1 below.

TABLE 1

| | Initial Decomposition |
|---|---|
| Fire Retardant Compound | Temperature in ° C. |
| Magnesium hydroxide | 340 |
| Aluminum trihydrate | 230 |
| Nesquehonite | 70-100 |
| Gypsum | 60-130 |
| Magnesium phosphate octahydrate | 140-150 |
| Hydromagnesite | 220-240 |
| Dawsonite | 240-260 |
| Magnesium carbonate subhydrate | 300-320 |
| Bohemite | 340-350 |
| Calcium hydroxide | 430-450 |
| Huntite | 450-800 |

Fire retardant compounds having an initial decomposition temperature above 200° C. are preferred. Fire retardant compounds having an initial decomposition temperature above 300° C. are especially preferred. Fire retardant compounds having an initial decomposition temperature above 400° C. are more especially preferred.

Thus, thermoplastics that can be used include, but are not limited to, ethylene methyl acrylate, polyethylene, polypropylene, acrylonitrile butadiene styrene, cellulose acetate, ethylene-vinyl acetate, polyacrylate, polyacrylonitrile, polyamide, polybutadiene, polybutylene, polybutylene terephthalate, polycaprolactone, polyethylene terephthalate, polycarbonate, polyester, polystyrene, polyurea, polyvinyl acetate, polyvinyl chloride, polyvinylidene chloride, styrene-acrylonitrile, ethyl butyl acrylate or mixtures thereof.

As stated above, the fire retardant composition comprises a fire retardant compound and a thermoplastic. The fire retardant compound comprises approximately 1% to approximately 99% by weight of the fire retardant composition; preferably, approximately 50% to approximately 80% by weight; especially, approximately 60% by weight. A particularly preferred fire retardant composition comprises approximately 60% by weight fire retardant compound, approximately 25% by weight ethylene methyl acrylate and approximately 15% by weight low density polyethylene. Low density polyethylene is known by those skilled in the art to have a density range of approximately 0.910 to approximately 0.940 g/cm³.

The fire retardant composition can also include additives, such as UV inhibitors, antistatic agents, antimicrobial agents and mixtures thereof. A UV inhibitor useful in the fire retardant composition is Lowilite 62 from Chemtura, Inc. of Philadelphia, Pa. An antistatic agent useful in the fire retardant composition is Entira Antistat 500 from Dupont Company of Wilmington, Del. An Antimicrobial agent useful in the fire retardant composition is Intersept from Interface, Inc. of Atlanta, Ga.

The preferred method of producing the fire retardant composition is by extruding the fire retardant compound and the thermoplastic together. The extruder can be either a single screw extruder or a twin-screw extruder. Furthermore, a twin-screw extruder can have either co-rotating or counter rotating screws. A suitable extruder is an 81 mm compounding extruder commercially available under the designation ZE 75A UTX from KraussMaffei Berstroff of Hannover, Germany. Such extruders also include heated barrels for heating and/or melting the materials being processed therein. The barrel temperature can be adjusted to a desired temperature depending on the fire retardant compound and the thermoplastic being used. The temperature must be high enough so that the thermoplastic can be melt blended with the fire retardant compound, but low enough so that the fire retardant compound does not thermally decompose. For the present invention, the barrel temperature of the extruder should be preferably approximately 325° F. to approximately 550° F., especially approximately 350° F. to approximately 450° F. The fire retardant compound and the thermoplastic are fed to the extruder through separate input ports at desired rates. If additives are desired, they can be fed through separate input ports or premixed with the fire retardant compound and the thermoplastic.

The output of the extruder is fed to a pelletizer; preferably, an underwater pelletizer. The underwater pelletizer cools the molten product from the extruder and cuts the product into pellets of a desired size. An underwater pelletizer suitable for use in the present invention is commercially available under the designation Gala 6 from Gala Industries, Eagle Rock, Va. The pelletizer produces the fire retardant of the present invention in the form of oval pellets, although pellets of other shapes and irregularly shaped pellets can also be used. Such pellets should have a particle size that is compatible with the particles making up the infill material so that the fire retardant particles do not segregate from the sand, ground recycled rubber tire material, or other materials that may make up the infill material. Generally, it is found in accordance with the present invention that the pellets of the fire retardant preferably have an average particle size of approximately 0.02 inches to approximately 0.25 inches; especially, approximately 0.125 inches (diameter or the largest dimension of the particles, if the particles are not of a uniform shape).

Use of the fire retardant composition will now be considered. The fire retardant composition of the present invention can be used in the manufacture of synthetic turf product. Or, the fire retardant composition can be used to treat existing synthetic turf products that do not have a fire retardant or that do not have sufficient fire retardant properties for the synthetic turf product to achieve a desired fire rating. If the fire retardant composition of the present invention is to be used for the manufacture of new synthetic turf, the particles are blended with the other materials that make up the infill material, such as the sand, ground recycled rubber tire particles and any other particles that make up the infill material. Alternately, the sand, ground recycled rubber tire particles and fire retardant composition can be applied in separate layers. Alternately, some of the infill material can be mixed together and some of the material applied in layers. The fire retardant composition is added to the infill material so that the fire retardant comprises approximately 15% by weight to approximately 35% by weight of the infill material. The infill material, including the fire retardant composition, is then incorporated into the synthetic turf in a manner well known in the art.

If the fire retardant composition of the present invention is to be used with existing synthetic turf that either does not have a fire retardant or needs additional fire retardant, the fire retardant composition of the present invention can be added to the synthetic turf. This can be done by spreading the fire retardant particles of the present invention on the surface of the face fibers of an existing synthetic turf already installed as a playing surface. The fire retardant particles are applied to the synthetic turf at a rate of approximately 0.5 to approximately 1.5 pounds per square foot of synthetic turf; preferably, approximately 0.6 to approximately 1.4 pounds per square foot of synthetic turf; especially, approximately 1.4 pounds per square foot. The surface of the face fibers of the synthetic turf is then raked, or otherwise manipulated, to disperse the fire retardant particles between adjacent face fibers and below the upper surface of the face fibers. The raking can be done manually or by pulling a rake behind a lawn tractor or four wheel drive vehicle.

It is also a feature of the present invention that recycled synthetic turf can be used as a portion, or all, of the thermoplastic from which the fire retardant composition of the present invention is made. As stated above, synthetic turf is made from a polyethylene face fiber tufted in a polypropylene primary backing material coated with a polyurethane (or latex) back coat to hold the fibers in place. There are also synthetic turf products that use polypropylene or polyamide face fibers. All of these materials are thermoplastics, except for the polyurethane or latex. However, the polyurethane or latex does not interfere with using the recycled synthetic turf in the present invention. Recycled synthetic turf is prepared as follows.

The preparation of thermoplastic pellet of recycled synthetic turf is discussed below. There are generally two classes of synthetic turf: post-consumer synthetic turf and post-industrial synthetic turf. Post-consumer synthetic turf contains an infill material that needs to be removed. Post-industrial synthetic turf does not include this infill material. The infill material is typically made from a mixture of sand and cryogenically ground tire rubber. The infill is used in synthetic turf, inter alia, to provide a cushioned feel to the synthetic turf and to aid in making the blades of synthetic grass stand upright giving the grass a more natural appearance. To be recycled in the present invention, at least 90% by weight of the infill must be removed from post-consumer synthetic turf; preferably 95% by weigh of the infill must be removed from post-consumer synthetic turf. This means that post-consumer synthetic turf for use in the present invention should contain less than 10% by weight infill material, preferably less than 5% by weight infill material, especially no infill material. There are several types of equipment on the market today for removing synthetic turf from an installation and removing infill from post-consumer synthetic turf. One such machine is the “Turf Muncher” available from Field Away, Dalton, Ga. The “Turf Muncher” both strips the synthetic turf from an installation and removes infill material therefrom. If a “Turf Muncher” is not available, the synthetic turf can be inverted; i.e., face fibers down, and the back of the turf can be beaten or vibrated so that the infill falls out of the turf.

After the infill material has been removed, if necessary, the synthetic turf is put through a size reduction process. The synthetic turf is fed into a shredder, grinder or chopper, which will reduce the synthetic turf to particles of a desired size. In the present invention, the synthetic turf should be reduced to particles no larger than about 1 inch in size; i.e., less than 1 inch in the largest dimension of an irregularly shaped particle. Suitable machines to perform this size reduction are available, such as the Series 13 and Series 14 Grinders from Jordan Reduction Solutions, Birmingham, Ala. or the series WLK25 shredder from Weima America, Inc. of Fort Mill, S.C. Such grinders or choppers usually include a rotating drum with knives attached thereto for cutting the material fed therein into desired sizes. Grading screens below the rotating drum permit particles of only a desired size to pass through.

The ground particles of the synthetic turf are fed into the input of an extruder and blended in a molten state. The extruder can be either a single screw extruder or a twin-screw extruder. Furthermore, a twin-screw extruder can have either co-rotating or counter rotating screws. The extruder should include at least one side feeder for introducing at least one processing agent into the extruder along with the synthetic turf particles. A suitable extruder is commercially available under the designation Model G6000 from PTI Extruders of Aurora, Ill. Such extruders also include heated barrels for heating and/or melting the materials being processed therein. The barrel temperature can be adjusted to a desired temperature. For the present invention, the barrel temperature of the extruder should be hot enough to melt the thermoplastic polymers being processed therein, preferably approximately 325° F. to approximately 550° F., especially approximately 350° F. to approximately 450° F. The output of the extruder can be pelletized in that same manner as the fire retardant, as described above. The pellets of the recycled synthetic turf can then be used as feed stock as a replacement, or partial replacement, for the thermoplastic polymer for making the fire retardant of the present invention. That is, the recycled synthetic turf can be used in making the fire retardant of the present invention in amounts from 0% to 100% by weight of the thermoplastic polymer. Pellets of recycled synthetic turf are commercially available under the designation ThermoTex 1311A from the ThermoTex Division of Textile Rubber and Chemical Company, Inc., Cartersville, Ga.

A significant benefit of the flame retardant of the present invention is that it is 100% recyclable.

The following examples are illustrative of selected embodiments of the present invention and are not intended to limit the scope of the invention.

### EXAMPLE 1

The formula in Table 2 below was used to prepare the flame retardant composition of the present invention.

TABLE 2

| Ingredient | Percent by Weight |
|---|---|
| Westlake EMAC SP2207 | 25 |
| Westlake Epolene C-10 LDPE | 15 |
| Cimbar Ultramag 60-90 | 60 |

Westlake EMAC SP2207 is an ethylene methyl acrylate copolymer of which 20% by weight is methyl acrylate. Westlake Epolene C-10 LDPE is a branched low density polyethylene homopolymer with a weight average molecular weight of 35,000. Cimbar Ultramag 60-90 is magnesium hydroxide.

The foregoing formulation was compounded through a 160 mm Werner & Pfleiderer, Stuttgart, Germany, compounding extruder with a barrel temperature of approximately 350° F. and pelletized using an underwater pelletizer from Gala Industries, Eagle Rock, Va. The resulting product was an oval pellet with an average size of 0.125″ diameter.

The testing procedure that was followed was ASTM E648-08 for Critical Radiant Flux of Floor Covering Systems Using A Radiant Heat Energy Source, which is also referenced as NFPA 253 and FTM Standard 372. The NFPA Life Safety Code 101 specifies the following rating criteria: Class 1 Critical Radiant Flux of 0.45 watts/cm² or higher; Class 2 Critical Radiant Flux of 0.22-0.44 watts/cm².

The flooring radiant panel test evaluates the tendency of a floor system to spread flame when exposed to radiant heating of a gas fired radiant panel. The method determines a material's critical radiant flux (measured in watts per square centimeter) the lowest intensity of radiant heat, which will cause a floor covering to propagate flame over its surface. The flooring radiant panel apparatus involves a 100×20 cm (39×8 inch) sample of floor covering which is horizontally mounted on the floor of the test chamber. The specimen receives the radiant energy exposure from an air-gas fueled radiant panel mounted above the specimen. The gas fired radiant panel generates a radiant heat energy exposure along the length of the specimen ranging from a maximum of approximately 1.1 watts per square centimeter immediately under the radiant panel to approximately 0.1 watts per square centimeter at the far end of the test specimen remote from the panel. A gas fired pilot burner is used to initiate flaming of the sample. The test is continued until the flooring system ceases to burn. The distance the flooring system burned is noted. The radiant heat energy exposure is noted at the point the flooring system “self-extinguished.” This measurement is reported as the sample's critical radiant flux. This value, critical radiant flux, is the minimum energy necessary to sustain flame propagation.

The synthetic turf used in this test consisted of a polyethylene face fiber with a 2.5″ pile height, a polypropylene primary and a polyurethane backing. The synthetic turf did not include any infill material. The following materials were then added in layers to the face of the synthetic turf as infill to represent real world application. The first layer was sand. The second layer was ground recycled tire rubber. The third layer was the fire retardant of the present invention. After each application, the face fibers were raked to distribute the applied material between adjacent face fibers and below the surface of the face fibers. The relative amount of these three materials that were added to the synthetic turf are listed below along with the Radiant Flux test results.

In each test, the total amount of infill material added to the synthetic turf was 4 pounds per square foot. In the Control test, no fire retardant was used. In Experiment A, fire retardant was added at the rate of 1.4 pounds per square foot of synthetic turf. In Experiment B, fire retardant was added at the rate of 0.6 pounds per square foot of synthetic turf. The results of the flooring radiant panel testing are set forth below.

### Control:

2 lbs/ft² Sand+2 lbs/ft² Rubber Crumb

Distance Burned: 100 cm

Time to Flame Out: 10 minutes

Critical Radiant Flux: 0.09 watts/cm²

No Rating

### Experiment A:

0.6 lbs/ft² Sand+2 lbs/ft² Rubber Crumb+1.4 lbs/ft² Fire Retardant

Distance Burned: 13 cm

Time to Flame Out: 18 minutes

Critical Radiant Flux: 1.11 watts/cm²

Class 1 Rating

### Experiment B:

1.4 lbs/ft² Sand+2 lbs/ft² Rubber Crumb+0.6 lbs/ft² Fire Retardant

Distance Burned: 53 cm

Time to Flame Out: 18 minutes

Critical Radiant Flux: 0.30 watts/cm²

Class 2 Rating

The foregoing test results show that the use of 0.6 pounds per square foot of the fire retardant of the present invention as infill material for synthetic turf provides a Class 2 rating for the synthetic turf; 1.4 pounds per square foot of the fire retardant provides a Class 1 rating, and, in fact, far exceeds the minimum standard for a Class 1 rating.

### EXAMPLE 2

The same procedure is followed as described above for Example 1, except that the formulation of the fire retardant is as shown in Table 3 below:

TABLE 3

| Ingredient | Percent by Weight |
|---|---|
| Westlake EMAC SP2207 | 20 |
| ThermoTex 1311A | 20 |
| Cimbar Ultramag 60-90 | 60 |

This flame retardant product provides the same Class 1 and Class 2 ratings for synthetic turf at similar loading levels as Example 1.

### EXAMPLE 3

The same procedure is followed as described above for Example 1, except that the formulation of the fire retardant is as shown in Table 4 below:

TABLE 4

| Ingredient | Percent by Weight |
|---|---|
| ThermoTex 1311A | 40 |
| Cimbar Ultramag 60-90 | 60 |

This flame retardant product provides the same Class 1 and Class 2 ratings for synthetic turf at similar loading levels as Example 1.

### EXAMPLE 4

The same procedure is followed as described above for Example 1, except that the formulation of the fire retardant is as shown in Table 5 below:

TABLE 5

| Ingredient | Percent by Weight |
|---|---|
| Westlake EMAC SP2207 | 25 |
| Westlake Epolene C-10 LDPE | 15 |
| Huber SB 336 | 60 |

This flame retardant product provides the same Class 1 and Class 2 ratings for synthetic turf at similar loading levels as Example 1.

### EXAMPLE 5

The same procedure is followed as described above for Example 1, except that the fire retardant compound shown in Table 6 below were substituted for the magnesium hydroxide use to make the fire retardant composition of Example 1:

TABLE 6

| Experiment No. | Fire Retardant Compound |
|---|---|
| 1 | Nesquehonite |
| 2 | Gypsum |
| 3 | Magnesium phosphate octahydrate |
| 4 | Hydromagnesite |
| 5 | Dawsonite |
| 6 | Magnesium carbonate subhydrate |
| 7 | Bohemite |
| 8 | Calcium hydroxide |
| 9 | Huntite |

Each of the Experiments 1-9 above produced a synthetic turf produce with flame retardant properties.

It should be understood, of course, that the foregoing relates only to certain disclosed embodiments of the present invention and that numerous modifications or alterations may be made therein without departing from the spirit and scope of the invention as set forth in the appended claims.

What is claimed is:

1. A composition comprising:
a fire retardant compound that thermally decomposes to release carbon dioxide or water or both; and
a thermoplastic polymer, wherein the composition is in the form of particles suitable for use as infill for synthetic turf products.

2. The composition of claim 1, wherein the fire retardant compound is magnesium hydroxide, aluminum trihydrate, Nesquehonite, gypsum, magnesium phosphate octahydrate, Hydromagnesite, Dawsonite, magnesium carbonate subhydrate, Bohemite, calcium hydroxide, Huntite or mixtures thereof.

3. The composition of claim 1, wherein the fire retardant compound comprises approximately 1% to approximately 99% by weight of the composition.

4. The composition of claim 1, wherein the fire retardant compound comprises approximately 50% to approximately 80% by weight of the composition.

5. The composition of claim 1, wherein the fire retardant compound comprises approximately 60% by weight of the composition.

6. The composition of claim 1, wherein the thermoplastic polymer is ethylene methyl acrylate, polyethylene or mixtures thereof.

7. The composition of claim 1, wherein the thermoplastic polymer is ethylene methyl acrylate, polyethylene, polypropylene, acrylonitrile butadiene styrene, cellulose acetate, ethylene-vinyl acetate, polyacrylate, polyacrylonitrile, polyamide, polybutadiene, polybutylene, polybutylene terephthalate, polycaprolactone, polyethylene terephthalate, polycarbonate, polyester, polystyrene, polyurea, polyvinyl acetate, polyvinyl chloride, polyvinylidene chloride, styrene-acrylonitrile, ethyl butyl acrylate or mixtures thereof.

8. The composition of claim 1, wherein the composition comprises
approximately 60% by weight magnesium hydroxide;
approximately 25% by weight ethylene methyl acrylate; and
approximately 15% by weight low density polyethylene.

9. The composition of claim 1, wherein the particles are in the form of extruded pellets.

10. The composition of claim 9, wherein the extruded pellets have an average particle size of approximately 0.02 to approximately 0.25 inches.

11. A synthetic turf product comprising:
a backing layer;
a plurality of face fibers extending upwardly from the backing layer; and
infill material between the plurality face fibers, the infill comprising a fire retardant composition in particulate form comprising:
a fire retardant compound that thermally decomposes to release carbon dioxide or water or both; and
a thermoplastic polymer.

12. The synthetic turf product of claim 11, wherein the fire retardant compound is magnesium hydroxide, aluminum trihydrate, Nesquehonite, gypsum, magnesium phosphate octahydrate, Hydromagnesite, Dawsonite, magnesium carbonate subhydrate, Bohemite, calcium hydroxide, Huntite or mixtures thereof.

13. The synthetic turf product of claim 11, wherein the fire retardant compound comprises approximately 1% to approximately 99% by weight of the fire retardant composition.

14. The synthetic turf product of claim 11, wherein the fire retardant compound comprises approximately 50% to approximately 80% by weight of the fire retardant composition.

15. The synthetic turf product of claim 11, wherein the fire retardant compound comprises approximately 60% by weight of the fire retardant composition.

16. The synthetic turf product of claim 11, wherein the thermoplastic polymer is ethylene methyl acrylate, polyethylene or mixtures thereof.

17. The synthetic turf product of claim 11, wherein the thermoplastic polymer is ethylene methyl acrylate, polyethylene, polypropylene, acrylonitrile butadiene styrene, cellulose acetate, ethylene-vinyl acetate, polyacrylate, polyacrylonitrile, polyamide, polybutadiene, polybutylene, polybutylene terephthalate, polycaprolactone, polyethylene terephthalate, polycarbonate, polyester, polystyrene, polyurea, polyvinyl acetate, polyvinyl chloride, polyvinylidene chloride, styrene-acrylonitrile, ethyl butyl acrylate or mixtures thereof.

18. The synthetic turf product of claim 11, wherein the fire retardant composition comprises:
approximately 60% by weight magnesium hydroxide;
approximately 25% by weight ethylene methyl acrylate; and
approximately 15% by weight low density polyethylene.

19. The synthetic turf product of claim 11, wherein the fire retardant particles are in the form of extruded pellets.

20. The synthetic turf product of claim 19, wherein the extruded pellets have an average particle size of approximately 0.02 to approximately 0.25 inches.

21. A method comprising:
applying to an upper surface of face fibers of a synthetic turf an amount of a particulate fire retardant composition sufficient to make the synthetic turf fire resistant, the fire retardant composition comprising a fire retardant compound and a thermoplastic polymer; and
dispersing the particulate fire retardant composition between adjacent face fibers and below the upper surface of the face fibers.

22. The composition of claim 21, wherein the fire retardant compound is magnesium hydroxide, aluminum trihydrate, Nesquehonite, gypsum, magnesium phosphate octahydrate, Hydromagnesite, Dawsonite, magnesium carbonate subhydrate, Bohemite, calcium hydroxide, Huntite or mixtures thereof.

23. The method of claim 21, wherein the fire retardant compound comprises approximately 1% to approximately 99% by weight of the fire retardant composition.

24. The method of claim 21, wherein the fire retardant compound comprises approximately 50% to approximately 80% by weight of the fire retardant composition.

25. The method of claim 21, wherein the fire retardant compound comprises approximately 60% by weight of the fire retardant composition.

26. The method of claim 21, wherein the thermoplastic polymer is ethylene methyl acrylate, polyethylene or mixtures thereof.

27. The method of claim 21, wherein the thermoplastic polymer is ethylene methyl acrylate, polyethylene, polypropylene, acrylonitrile butadiene styrene, cellulose acetate, ethylene-vinyl acetate, polyacrylate, polyacrylonitrile, polyamide, polybutadiene, polybutylene, polybutylene terephthalate, polycaprolactone, polyethylene terephthalate, polycarbonate, polyester, polystyrene, polyurea, polyvinyl acetate, polyvinyl chloride, polyvinylidene chloride, styrene-acrylonitrile, ethyl butyl acrylate or mixtures thereof.

28. The method of claim 21, wherein the fire retardant composition comprises:
approximately 60% by weight magnesium hydroxide;
approximately 25% by weight ethylene methyl acrylate; and
approximately 15% by weight low density polyethylene.

29. The method of claim 21, wherein the fire retardant composition is in the form of extruded pellets.

30. The method of claim 29, wherein the extruded pellets have an average particle size of approximately 0.02 to approximately 0.25 inches.

31. The method of claim 21, wherein the fire retardant composition is applied to the synthetic turf in the amount of approximately 0.5 to approximately 1.5 pounds per square foot.

32. The method of claim 21, wherein the fire retardant composition is applied to the synthetic turf in the amount of approximately 0.6 to approximately 1.4 pounds per square foot.

33. The method of claim 21, wherein the fire retardant composition comprises approximately 10% to 50% by weight of the infill material.

34. The method of claim 21, wherein the fire retardant composition comprises approximately 15% to 35% by weight of the infill material.

35. A product comprising a mixture of:
sand;
ground rubber; and
a fire retardant composition comprising:
magnesium hydroxide; and
a thermoplastic polymer, wherein the fire retardant composition is in the form of particles suitable for use as infill for synthetic turf products.
